(19) United States
(12) Patent Application Publication
(10) Pub. No.: US 2020/0081254 A1
(43) Pub. Date: Mar. 12, 2020

(54) APPARATUS TO ACHIEVE COMPACT HEAD MOUNTED DISPLAY WITH REFLECTORS AND EYEPIECE ELEMENT

(71) Applicant: Sharp Kabushiki Kaisha, Osaka (JP)

(72) Inventors: Ka Ho TAM, Oxford (GB); David James MONTGOMERY, Oxford (GB)

(21) Appl. No.: 16/469,539

(22) PCT Filed: Dec. 14, 2017
(86) PCT No.: PCT/JP2017/044854

§ 371 Date: Jun. 13, 2019

(30) Foreign Application Priority Data
Dec. 19, 2016 (GB) 1621621.0

(51) Int. Cl. G02B 27/01; G02B 3/08

(52) U.S. Cl. CPC G02B 27/0172; G02B 3/08; G02B 27/0179; G02B 27/0176; G02B 2027/0152; G02B 2027/0178; G02B 2027/0187; G02B 2027/015; G02B 2027/0123

(57) ABSTRACT

An optical system enables high image quality Head Mounted Displays to be made more compact and/or of reduced weight. The optical system includes at least two or more image panels per eye, two or more reflective surfaces per image panel, and a refractive eyepiece element. Light from each image panel is reflected by a distinct set of optical surfaces before reaching the eye, forming at least two overlapping virtual images per eye. The invention may allow the apparatus to have a compact form factor with weight distribution close to the user's face without compromising on image quality and resolution.

### TECHNICAL FIELD

The invention has application within the field of wearable displays. It is used for achieving a compact and light weight design in head mounted displays.

### BACKGROUND ART

A Head-Mounted-Display (HMD) is a type of device with increasing popularity within the consumer electronics industry. HMDs, along with similar devices such as helmet-mounted displays, smart glasses, and virtual reality headsets, allow users to wear a display device such that the hardware remains fixed to their heads regardless of the person's movement.

When combined with environmental sensors such as cameras, accelerometers, gyroscopes, compasses, and light meters, HMDs can provide users with experiences in virtual reality and augmented reality. Virtual reality allows a user to be completely submerged into a virtual world where everything the user sees comes from the display device. On the other hand, devices that provide augmented reality allow users to optically see the environment. Images generated by the display device are added to the scene and may blend in with the environment.

One of the primary elements of HMDs is a display module mounted onto the head. However, since the unaided human eye cannot accommodate (that is, change its optical power to provide a focused image) for images closer than a certain distance from the eye, eye piece lenses are required to re-image the display module such that the display appears to be at a comfortable viewing distance from the user. Such optical configuration requires lots of space between the eye piece and the display module. Furthermore, complex lenses are needed if the HMD needs to display images with high quality and wide field of view (FoV). These lenses often make the device very bulky to wear.

A number of methods have been proposed to eliminate the need of heavy lenses in HMDs. Light field displays use a high resolution image panel with a microlens array to integrate subsets of images onto different parts of the retina. This method leads to images with low effective resolution. Retinal scanning displays are capable of producing images with resolution equivalent to the native resolution of the laser scanner. However, the stringent requirement to align the scanning mirror through the eye's pupil means that it is very difficult to fabricate an HMD that fits different anthropometric variations.

U.S. Pat. No. 8,508,851B2 (Miao et al., published 13 Aug. 2013) proposes a see-through display system that reflects light from a display panel using a beam splitter. Although the system is made compact by using a concave mirror, the field of view (FoV) of such system is limited as curved reflective surfaces can only provide low aberrations across very small FoV. In addition, the concave mirror means that the design is only suitable for small display panels. This limits the total resolution of the display system.

US20140168783A1 (Luebke et al., published 19 Jun. 2014) proposes the use of an optical system which uses a plurality of microlenses located in the near-eye range of an observer to simulate an object that is in focus to the observer. This method inevitably trades-off the resolution of the display for thickness. Furthermore, because the pixels of the panel are subjected to high magnification by a single curved optical surface, the image of the pixels will be severely aberrated, leading to very poor image quality.

US20020181115A1 (Massof et al., published 5 Dec. 2002) proposes a head mounted display that is comprised of a plurality of lenses and plurality of displays arranged tangent to a sphere. This design would result in a head mounted display that is heavy and expensive due to the large number of components present.

U.S. Pat. No. 9,244,277B2 (Cheng et al., published 26 Jan. 2016) and WO2016118643A1 (Benitez et al., published 28 Jul. 2016) propose head mounted displays that comprise of a plurality of tiled-up display channels each made from a prism with free-form surfaces and a micro-display. However, such system may be heavy as the solid volumes of the prisms need to be thick enough to accommodate for the microdisplays. Furthermore, the micro-display modules, which may be mounted on driver electronics, are located at a significant distance away from the users' face. This would shift the centre of mass of the whole system forward beyond the nose of the user, contributing to a downward tilting moment which may be required to be balanced with an uncomfortable head strap.

WO2016118647A1 (Benitez et al., published 28 Jul. 2016) proposes a display device which is comprised of one or more lenslet magnifying a cylindrical display surface. To achieve a virtual image that the eye can focus on, the display surface will need to be physically located at least several centimetres from the users' face. On the other hand, U.S. Pat. No. 6,008,778A (Takahashi et al., published 28 Dec. 1999) proposes a display apparatus that has two display units per eye wherein a surface which is partially transmitting and partially reflecting is being disposed to face the observer's eyeball with the panel further away from the face of the user. Again, both of these two designs will lead to a system with centre of mass far away from the user and contribute to discomfort.

Other examples of display devices are proposed in EP 2253989 (Canon KK), JP-H07-79393 (Olympus Co), EP 2565700 (Canon KK), US 2010/290125 (Canon KK) and JP-2012-247480 (Canon KK).

### SUMMARY OF INVENTION

A first aspect of the present invention provides an optical system comprising: a first display panel for displaying a first image; a second display panel for displaying a second image; first and second eyepiece elements, the first eyepiece element having a first optical axis and the second eyepiece element having a second optical axis, the first optical axis extending generally parallel to, but offset from, the second optical axis; a first reflective element for directing light from the first display panel along a first optical path through the first eyepiece element to a viewing zone of the optical system for forming a first virtual image of the first image; and a second reflective element for directing light from the second display panel along a second optical path through the second eyepiece element to the viewing zone of the optical system for forming a second virtual image of the second image, the first optical path being different from the second optical path, and the first and second virtual images overlapping one another.

The optical system may be a wearable optical system, arranged such that, when the optical system is being worn by a user, the user's eye(s) is/are in the viewing zone of the optical system so that the user can perceive an image derived from the first and second images as displayed on the first and second display panels. The use of reflective elements allows the display panels to be physically located closer to the user's face than in, for example, U.S. Pat. No. 6,008,778. This allows most of the weight of the apparatus to be maintained closer to the user's face, making the optical system more compact and providing a more comfortable weight distribution. At the same time, the eyepiece elements (which have at least one surface with positive optical power) ensure that, despite the compact size of the optical system, the virtual images are located at a distance at which the user's eyes can comfortably focus.

The first display panel may be on the same side of the first reflective element as the viewing zone; and/or the first eyepiece element may be on the same side of the first reflective element as the viewing zone. Again, this allows the weight of the optical system to be maintained closer to the user's face.

Additionally or alternatively the second display panel may be on the same side of the second reflective element as the viewing zone, and/or the second eyepiece element may be on the same side of the second reflective element as the viewing zone. Again, this allows the weight of the optical system to be maintained closer to the user's face.

The first display panel may be laterally spaced apart from the second display panel, and optionally the first display panel and the second display panel may lie generally in a common plane. Further optionally, the first and second eyepiece elements may lie generally in a common plane with the first display panel and the second display panel.

Further optionally, the first and second eyepiece elements may be provided between the first display panel and the second display panel. This allows the optical system to be made physically compact, and again allows the weight of the optical system to be maintained closer to the user's face so making the optical system, when embodied as a wearable optical system, more comfortable for the user to wear.

In any aspect or embodiment the first eyepiece element and the second eyepiece element may be separate components. Alternatively, the first eyepiece element and the second eyepiece element may be formed as a single component.

Similarly, in any aspect or embodiment the first reflective element and the second reflective element may be separate components. Alternatively, the first reflective element and the second reflective element may be formed as a single component. As a further alternative, the first reflective element may be formed of two or more components and/or the second reflective element may be formed of two or more components.

It should be understood that specifying that optical system comprises first and second display panels does not mean that the optical system is limited to only two display panels. In other embodiments the optical system may have three, or even more, display panels. Similarly, specifying that optical system comprises first and second eyepiece elements does not mean that the optical system is limited to only two eyepiece elements, and the optical system could comprises more than two eyepiece elements. Preferably, the number of eyepiece elements is equal to, or greater than, the number of display panels so that the optical path from each display panel to the viewing zone passes through a respective, different eyepiece element.

In embodiments an optical system of the invention may have any (that is, may have one, more than one, or all) of the following optional features. It should be noted that, to avoid repetition, some of these features are defined with reference to only the first display panel, the first eyepiece element and/or the first reflective element. However, any feature defined with reference to the first display panel, the first eyepiece element and/or the first reflective element may alternatively or additionally be applied to the second display panel, the second eyepiece element and/or the second reflective element.

The first display panel may be on the same side of the first reflective element as the viewing zone.

The first eyepiece element may be on the same side of the first reflective element as the viewing zone.

For light emitted by at least a part of the first display panel, the first optical path may comprise multiple reflections by the first reflective element.

The first display panel may have a luminance profile that varies over the area of the first display panel.

The luminance profile of a region of the first display panel closer to the first eyepiece element may be narrower than the luminance profile of a region of the first display panel further from the first eyepiece element.

The first display panel may comprise an image display panel disposed in the path of light from a directional backlight. Additionally or alternatively the first display panel may comprise a light directing means disposed in the path of light from an image display panel.

The first eyepiece element may comprise at least one Fresnel lens.

The first eyepiece element may comprise a first segment and a second segment, the first eyepiece element and the first reflective element being arranged such that, for light emitted by at least a part of the first display panel, the first optical path comprises, in sequence, a first reflection by the first reflective element, refraction by the first segment of the first eyepiece element, a second reflection by the first reflective element, and refraction by the second segment of the first eyepiece element.

The second segment of the first eyepiece element may extend in a direction crossed with the first segment. It may for example extend substantially perpendicular to the first segment.

The first segment of the first eyepiece element may comprise a first Fresnel lens and/or the second segment of the first eyepiece element may comprise a second Fresnel lens.

The first reflective element may comprise a light guide arranged such that, for light emitted by a first part of the first display panel, the first optical path does not pass through the light guide, and such that, for light emitted by a second part of the first display panel, the first optical path passes through the light guide.

The second part of the first display panel may be closer to the viewing zone than is the first part of the first display panel.

The optical system may comprise an optical blocker for blocking light emitted by the first part of the first display panel from entering the light guide. The optical blocker may for example comprise a polarising element. In one implementation light from the first part of the first display panel may have a polarisation that is blocked or substantially blocked by the polarising element and light from the second part of the first display panel may have a polarisation that is transmitted substantially transmitted by the polarising element.

The optical system may comprise a further reflective element arranged such that the first light path further includes a reflection by the further reflective element.

The first display panel may be arranged to emit light of a first polarisation and the second display panel may be arranged to emit light of a second polarisation orthogonal or substantially orthogonal to the first polarisation; the first reflective element may be arranged to substantially reflect light of the first polarisation and to substantially transmit light of the second polarisation, and the second reflective element may be arranged to substantially reflect light of the second polarisation and to substantially transmit light of the first polarisation.

The optical system may comprise a lens array provided in the first optical path.

The optical system may comprise a gaze tracker for determining the position and/or orientation of an eye of a user of the optical system.

The optical system may be adapted to control the first image display panel and/or the second image display panel based on an output of the gaze tracker.

The first image display panel and/or the second image display panel may be non-flat.

Alternatively the first image display panel and the second image display panel may both be flat image display panels.

A second aspect of the invention provides a head mounted display comprising an optical system of the first aspect.

This invention concerns a design of a wearable display which enables the device to have reduced weight and increased compactness relative to known configurations without compromising other technical performances. The design is particularly suitable for a head mounted display or smart glasses with applications in virtual reality (VR) and augmented reality (AR).

The principle of the present design involves the creation of a wide field of view (FoV) image by conglomerating multiple display segments onto the user's retina. The system includes two or more image panels per eye, two or more planar reflective surfaces per image panel, and a refractive eyepiece element. Light from each image panel is reflected by a distinct set of optical surfaces before reaching the eye, forming at least two overlapping virtual images per eye. In addition, light from each virtual image is refracted by at least one optical surface with positive power such that their virtual images are located at a distance that the user's eye can comfortably focus on.

The present invention allows the image panel to be physically located at a position closer to the user's face than the centre of mass of other optical components. This geometry allows most of the weight of the apparatus to be maintained close to the user's face, providing a comfortable weight distribution.

For example, if the apparatus is fitted into a housing that resemble the shape of regular prescription eyeglasses, a system with a centre of mass close to the face would allow its torque about the nose pad to be minimised. This could potentially enable the apparatus to be secured relative to the head by resting on the ears and nose of the user, rather than requiring a strap around the head.

In a preferred embodiment, the apparatus includes two image panels, an eyepiece element, and a primary reflective element. The two image panels are positioned on two opposite ends of the apparatus with respect to the eyepiece element, as the panels are designed to be panels are located above and below the eye. Light emitted from each image panel is then transferred to the eye through a number of optical surfaces. Light is firstly reflected by a first and a second surface in the primary reflective element, followed by refraction from a positive Fresnel lens surface before reaching the eye.

The preferred image panels are standard liquid crystal panels, but could also be other known image panel technologies such as Organic Light Emitting Diode (OLED). In order to reduce crosstalk between unwanted optical surfaces, the panels may be designed to have a spatially varying luminance profile. For example, in liquid crystal displays such luminance profile can be achieved using known directional backlight designs or by using a louvre sheet after the image panel.

Although the preferred embodiment described the use of Fresnel lens surfaces reduce the system's total weight, it is also possible that at least one of these surfaces is substituted by other known lens surface types. For example, the refractive Fresnel lens surface may be substituted by a lens surface with continuous curvature, holographic, or diffractive elements.

Subsequent embodiments describe alternative schemes that also include similar arrangement of the reflective element and the use of an eyepiece element with at least two optical axes. In one embodiment, the apparatus has at least two positive power surfaces per optical path. In another embodiment, light from the image panel that contributes to a larger field of view are transmitted through a different light path than light that contributes to a smaller field of view. This could allow the centre of the image to have higher image quality than peripheral field of view while keeping the apparatus compacted.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

In the annexed drawings, like references indicate like parts or features:

FIG. 1: First embodiment of this invention, showing the principal optical elements.

FIG. 2: First embodiment, showing a possible surface curvature shape of the eyepiece element.

FIG. 3: First embodiment, showing a possible shape of the Fresnel eyepiece element.

FIG. 4: First embodiment, showing the overlapping of the virtual images created by the image panel FIG. 4(a): The HMD is viewed with the eye at the centre of the apparatus. FIG. 4(b): The HMD is viewed with the eye offset from the centre and rotated at an angle from the optimal viewing position. FIG. 4(c): Showing the field of view from the top half of the HMD as being larger than the angular size of the second reflective surface of the primary reflective element.

FIG. 5: Second embodiment, showing a method to achieve low crosstalk using an image panel with spatially varying luminance profile.

FIG. 6: Third embodiment, showing a configuration where the eyepiece element includes three segments.

FIG. 7: Third embodiment, showing a possible shape of the eyepiece element.

FIG. 8: Third embodiment, showing a possible shape of the Fresnel eyepiece lens.

FIG. 9: Fourth embodiment, wherein the apex of the reflective surfaces are replaced by a multi-bounced optical element.

FIG. 10: Fourth embodiment, showing the light path for the image at small field of view.

FIG. 11: Fourth embodiment, showing the light path for the image at large field of view.

FIG. 12: Fourth embodiment, showing a possibility that the light guiding component can have curved surfaces.

FIG. 13: Fifth embodiment, wherein partially reflective surfaces are used in the apparatus to increase the optical distance from the image panel to the eyepiece lens.

FIG. 14: Sixth embodiment, wherein partially reflective surfaces are used to increase the overlapping of the virtual images.

FIG. 15: Seventh embodiment, wherein a lens array is used to create multiple overlapping image segments on the retina from each image panel.

FIG. 16: Eighth embodiment, wherein the full head mounted display includes at least one image panel which is shared by both eyes.

FIG. 17: Ninth embodiment, wherein the eyepiece lens is made from a single prism block.

FIG. 18: Tenth embodiment, wherein the system includes a gaze tracker to so that image transformation can be dependent on eye position.

FIG. 19: Eleventh embodiment, wherein the elements are curved.

FIG. 20: Eleventh embodiment, wherein the elements are bent in the same direction as the head.

### DESCRIPTION OF EMBODIMENTS

An aspect of this invention is a head mounted display or similar display devices that are fixed to the head. In exemplary embodiments, the display device includes two or more image panels per eye, two or more planar reflective surfaces per image panel, and a refractive eyepiece element.

### Embodiment 1

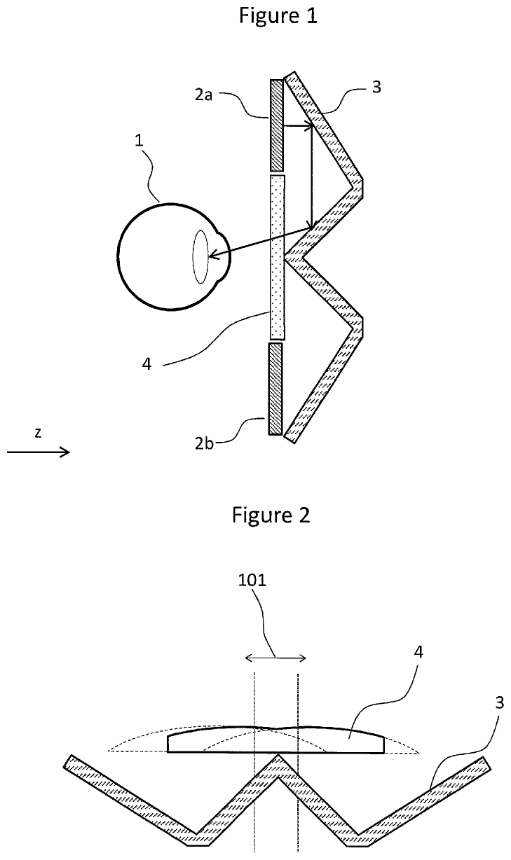

The first embodiment of this invention is shown in FIGS. 1-4.

FIG. 1 shows the components in the preferred embodiment. As shown, the embodiment of FIG. 1 has a first display panel 2a for displaying a first image and a second display panel 2b for displaying a second image. The first and second display panels are controlled by one or more controllers (not shown) to display first and second images respectively. In general, the first image and second image are video images (that is, are first and second image sequences), but the first image and second image may in principle be still images.

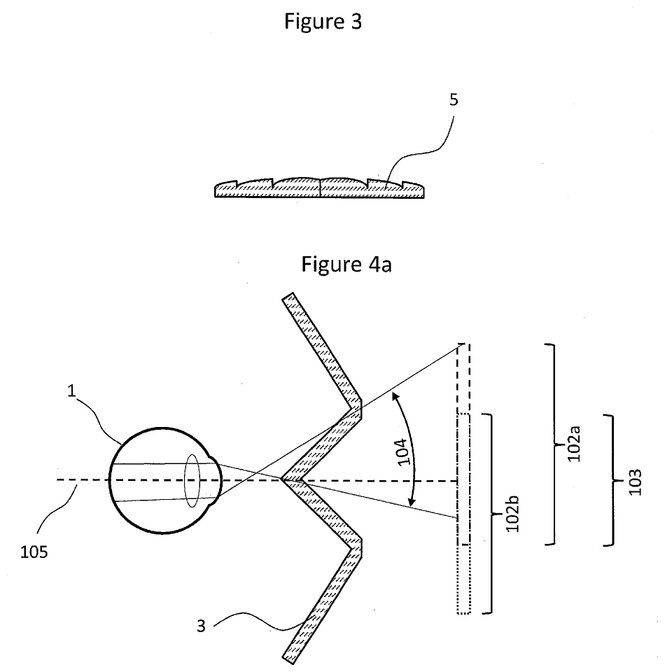

The embodiment of FIG. 1 further has first and second eyepiece elements, the first eyepiece element having a first optical axis and the second eyepiece element having a second optical axis, the first optical axis extending generally parallel to, but offset from, the second optical axis. In this example the first eyepiece element and the second eyepiece element are embodied as a single eyepiece element 4, as shown more clearly in FIG. 2 or 3, but the invention is not limited to this.

The embodiment of FIG. 1 further has a first reflective element for directing light from the first display panel 2a along a first optical path through the first eyepiece element to a viewing zone of the optical system for forming a first virtual image of the first image, and a second reflective element for directing light from the second display panel 2b along a second optical path through the second eyepiece element to the viewing zone of the optical system for forming a second virtual image of the second image, the first optical path being different from the second optical path, and the first and second virtual images overlapping one another. In this example the first reflective element and the second reflective element are embodied as a single reflective element 3, but the invention is not limited to this.

In the embodiment of FIG. 1 the first display panel 2a is on the same side of the first reflective element 3 as the viewing zone, and the first eyepiece element 4 is on the same side of the first reflective element 3 as the viewing zone. Similarly in the embodiment of FIG. 1 the second display panel 2b is on the same side of the second reflective element 3 as the viewing zone, and the second eyepiece element 4 is on the same side of the second reflective element 3 as the viewing zone. In this example the first display panel 2a is laterally spaced apart from the second display panel 2b, and the first and second eyepiece elements 4 are provided between the first display panel 2a and the second display panel 2b. In this example the first display panel 2a and the second display panel 2b may lie generally in a common plane, although the invention is not limited to this. Also in this example the first display panel 2a, the second display panel 2b and the eyepiece elements 4 may lie generally in a common plane, although the invention is not limited to this.

In this embodiment, the system includes two image panels per eye (2a-2b), a reflective optical element 3, and an eyepiece element 4. The image panels 2a,2b, the reflective optical element 3, and the eyepiece element 4 extend generally perpendicular to the plane of the paper. Where the invention is implemented in, for example, a head mounted display, the image panels 2a,2b, the reflective optical element 3, and the eyepiece element 4 may be provided separately for each eye of the user; alternatively one or more, and possibly all, of the image panels 2a,2b, the reflective optical element 3, and the eyepiece element 4 may be common to both eyes.

It should be noted that FIG. 1 is a cross section through one viewing zone of the optical system—when an apparatus incorporating the optical system (such as an HMD) is in use, a user's eye 1 will be located in the viewing zone. In general it will be desired for the apparatus to have two viewing zones, one for each eye of the observer—this may be done by providing separate optical systems each of which generates one viewing zone, or by arranging for a single optical system to generate two viewing zones.

These two image panels 2a, 2b are positioned on the opposite sides of the eyepiece element 4 respectively, such that they are positioned above and below the eye 1 when the apparatus is viewed by a user. For convenience the image panels will be described as being “above” and “below” the eye, but it should be understood that the terms “above” and “below” relate to the apparatus in use in its intended orientation. Light emitted from each panel is reflected by a first reflective surface of the primary reflective element 3, reflected by a second reflective surface of the primary reflective element, followed by refraction from a positive power eyepiece element 4, before leaving the apparatus towards the user's eye 1. (Details of the surface curvature of the eyepiece element are omitted from FIG. 1 for clarity, but are shown in FIGS. 2 and 3.) The two image panels are magnified by the eyepiece element 4 such that two virtual images are formed at approximately equal distance >300 mm away from the user at a distance that can be focused by the eye. In order for the user to see a continuous image from the apparatus, it is also necessary for these two virtual images to partially overlap in space.

In a preferred embodiment the image panels 2a, 2b are liquid crystal display panels, but similar function may also be achieved using other known image panel technologies, such as organic light emitting diodes (OLEDs).

A preferred primary reflective element 3 includes four reflective surfaces segments per eye, where one pair of reflective surfaces is used to reflect light from each of the image panels. In this embodiment, as shown in FIG. 1, for light emitted by at least a part of the first display panel 2a, the optical path from the first display panel 2a to the viewing zone comprises multiple reflections by the reflective element; this is also true for the optical path (not shown) from the second display panel 2b to the viewing zone. Each reflective surfaces described in this embodiment are planar, but may also have some small negligible dioptre power compared to the surfaces of the eyepiece element 4. Each of the surfaces could have a normal orientated 45 plus or minus 15 degree from the z-axis. In order to minimise cost, the reflective surfaces can simply be metallically coated. However, each reflective surface may be achieved using other known methods such as reflective dielectric coating, Fresnel reflection, or total internal reflection.

A schematic representation of the surface curvature of eyepiece element 4 is shown in FIG. 2. The element includes two convex surfaces. The convex surfaces could be located on the eye-facing side of the element. But in alternative configurations the curved surfaces may also be featured on the opposite side, or both sides of the element. The curvature surface exhibit some degree of discontinuity along a line which, when assembled, is aligned with an edge of the primary reflective element (Numeral 3, FIG. 1), giving two optical axes separated by some distance 101. Separation of these two optical axes would allow the virtual images of the two images panels to overlap by an increasing angle, enabling an increased eye box size.

In practice, in the preferred embodiment the curvature of the eyepiece element can be preserved by converting such element into a Fresnel lens as shown in FIG. 3. By doing so, the thickness and weight of the element can be greatly reduced. In addition, the element may also include other known technologies for refracting or diffracting light for achieving a thin form factor lens with low aberrations.

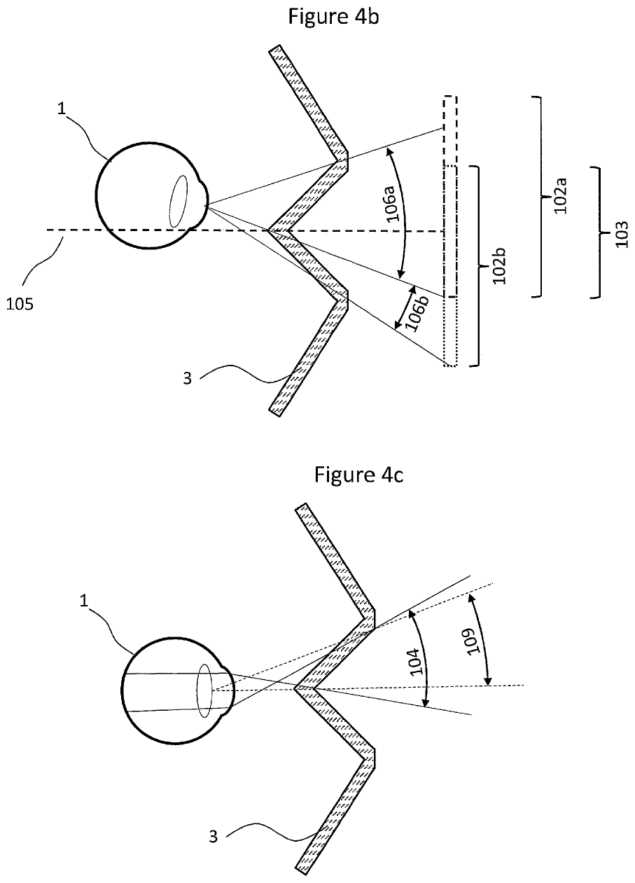

FIGS. 4a-4c describes the principle of the preferred embodiment, where virtual images of top and bottom image panels 102a, 102b are created with the use of the eyepiece element and the reflective element 3. (The eyepiece element is omitted from FIGS. 4a and 4b for clarity.) Virtual images of the two panels overlap by some area 103. The size of the reflective element imposes a restriction over the visible areas of the two image panels. FIG. 4a shows the eye being positioned about the plane of discontinuity 105 (the plane that divides rays from the upper image panel 2a from rays from the lower image panel 2b) of the apparatus. This position is also the ideal viewing position of the apparatus. Here the user would be able to see the image of the top panel with a field of view 104. FIG. 4c shows that, because of the finite pupil size of the eye, this field of view will be slightly larger than the angular extent 109 of the second reflective surface on element 3. The field of view of the bottom image panel will have a field of view complementary to 104 but with some overlapping such that the image would appear continuous to the user.

However, due to inevitable mis-positioning between the eye and the apparatus, in practice the centre of the eye will generally be at some distance from the ideal viewing position. In this case, the reflective element 3 will impose different FoV restrictions (106a, 106b) over the top and bottom images. Therefore, a design with a larger overlap 103 will allow the system to have larger eye box size.

It is worth mentioning that, although the optical elements in this embodiment have been drawn to be symmetrical above and below the eye, this does not have to be the case. The profile of the various elements above and below the eye could be asymmetrical to be optimised based on field of view versus resolution requirement of the human eye and weight distribution of the apparatus. As an example, because the fovea of the human eye is located above the optical axis of the eye's refractive elements, images located slightly below the human eye's line of sight will generally have greater importance than images above the line of sight. These considerations may be taken into account of such factors such that the overlapping regions of the top and bottom images, which could be susceptible to artefacts, are located some angle away from the fovea.

Subsequent embodiments in this description will be made in reference to the first embodiment and only the differences between the subsequent embodiments and the first embodiments will be discussed.

### Embodiment 2

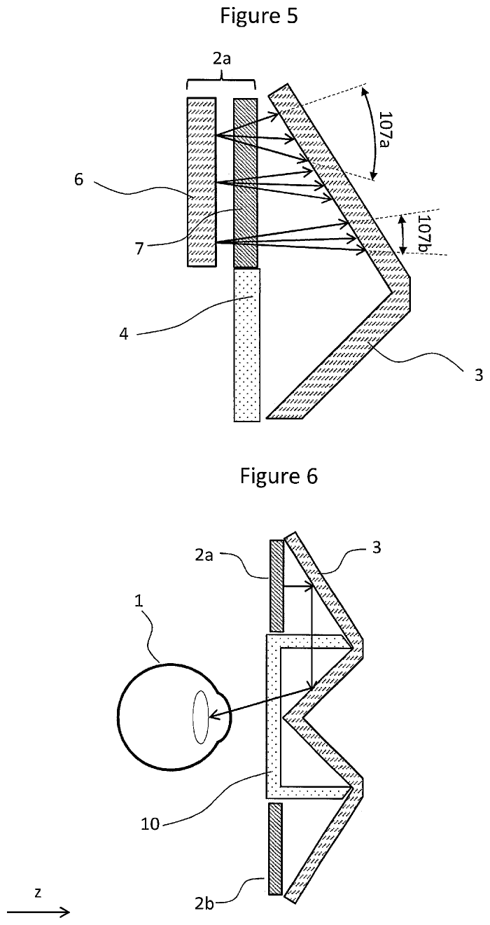

FIG. 5 shows the second embodiment describing a possible design of the preferred LCD image panel 2a. The image panel has a luminance profile that varies over its area. In this example the image panel includes an illumination unit 6 and a light modulating unit 7. The illumination unit is a known backlight design with a spatially varying luminance profile; whereas a light modulating unit is a standard LCD screen or other suitable modulator. Using an image panel with a luminance profile that varies over its area, for example by using backlight with spatially variable luminance profile (also known as a directional backlight unit), could reduce crosstalk from the image panel between the wrong optical surfaces. As one example of a spatially varying luminance profile, the region where the image panel is closer to the eyepiece element (which contributes to peripheral FoV of the final image) could be designed to have a narrower luminance profile 107b (that is, a smaller luminance angular range) than the region further away from the eyepiece element (which contributes to centre FoV of the final image) 107a. This would reduce unwanted crosstalk directly from the panel 2a to the second reflective surface of the reflective element 3 or the eyepiece element 4.

Similar results to reduce crosstalk may also be achieved with other known methods. For example, a light directing means, such as a louvre sheet (or privacy screen), may be placed after the light modulating unit 7. The louvre sheet may have grid size and shape that varies along different areas of the image panel. If a louvre sheet is used after an LCD image panel, then the element 6 may be an ordinary LCD backlight (or another non-directional backlight) instead of a directional backlight. However, if the image panel is based on OLED rather than LCD, a backlight would not be needed, meaning that in this case a louvre sheet would be the preferred solution to achieve low crosstalk.

### Embodiment 3

The third embodiment of this invention is shown in FIGS. 6-8.

FIG. 6 shows the components in the third embodiment. In this embodiment, the eyepiece element 10 includes three segments which shall be known as a primary segment and two secondary segments. The secondary segments of the eyepiece may extend in respective directions that are crossed with, and optionally are perpendicular or substantially perpendicular to, the primary segment of the eyepiece. The segments of the eyepiece element may form a “U-shape” when looked upon sideways. Light emitted from each panel is reflected by a first reflective surface of the primary reflective element 3, which is then refracted by a first segment (one of the secondary segments) of the eyepiece element 10. The same ray is followed by a reflection from a second reflective segment of the primary reflective element, followed by refraction from a second segment of the eyepiece element, before leaving the apparatus towards the user's eye 1.

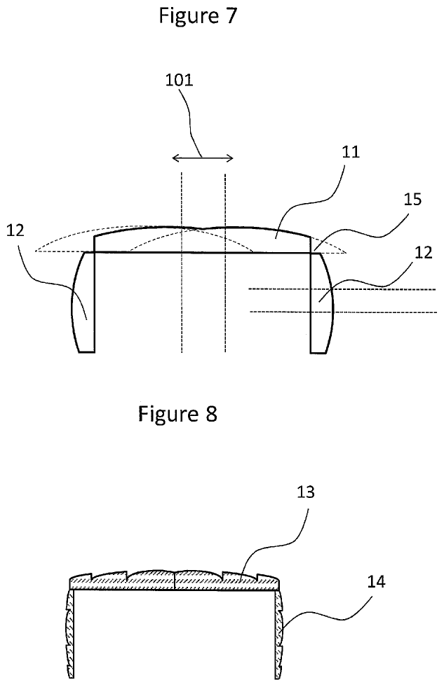

Details of the surface curvature of the eyepiece element are omitted from FIG. 6 for clarity. A schematic representation of the surface curvature of eyepiece element 10 is shown in FIG. 7. Both the primary segment 11 and the two secondary segments 12 of the eyepiece element may have a positive optical power and therefore could have a convex surface profile. In FIG. 7 all the convex surfaces are located on the outward-facing side of the element, but in alternative configurations the curved surfaces may alternatively be featured on the opposite sides, or on both sides of the element. The curvature of the primary segment may have a profile described in the primary embodiment. In addition, the optical axis of the secondary segment 12 may not be located at the centre of the said segment, but instead could be offset from the segment centre so as to allow the image panel to have a viewing zone that is suitable of the natural motion of the eye.

Because the optical axis of the individual lens surfaces may be offset from the main optical axis of the eye, aberrations such as oblique astigmatism may have a significant effect on image quality of the apparatus. To overcome this, the surface curvature on both the primary and secondary segments 11-12 will need to be free form surfaces described in the form of generalised polynomials. Such surfaces can be cheaply mass manufactured using techniques such as injection moulding.

Although the eyepiece element may be manufactured as multiple pieces, to save assembling costs, the whole eyepiece element may also be injection moulded as a single piece. If the design of the master mould proves to be costly, the eyepiece element can also be designed to be moulded as a single piece with flexible/living hinges located at the joint between the primary and secondary segments of the eyepiece element 15. In such case the curved surfaces of all the segments can be formed by a single master, where the hinge may be bent to wrap the eyepiece element into a “U-shape” in the assembly process.

The curvature of this eyepiece element can also be preserved by converting one or more, and optionally all, of the primary and secondary segments of such element into a Fresnel lens as shown in FIG. 8. By doing so, the thickness and weight of the element can be greatly reduced while the focal length properties of each segments 13, 14 can be maintained.

### Embodiment 4

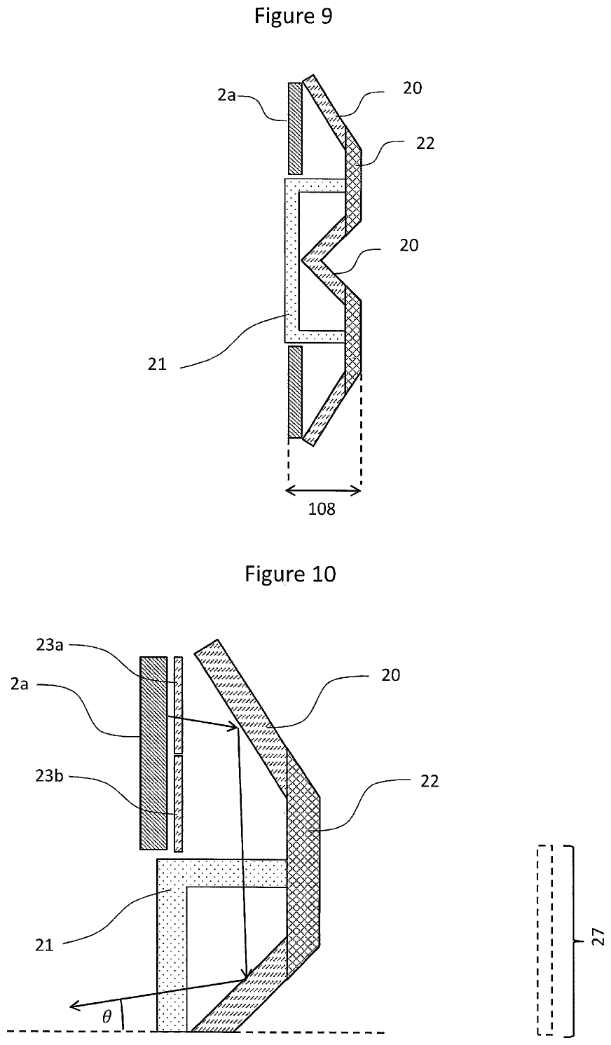

The fourth embodiment is shown in FIG. 9, with the main difference from the third embodiment being that the apex of the original reflective element and eyepiece element (3 and 10, FIG. 6) have been truncated (illustrated as 20 and 21). The truncated thickness is partially replaced by a light guiding component 22. The light guide guiding component 22 is arranged such that, for light emitted by a first part of the first display panel 2a, the optical path from the first display panel to the viewing zone does not pass through the light guide guiding component 22, and such that, for light emitted by a second part of the first display panel 2a, the optical path from the first display panel to the viewing zone does pass through the light guide guiding component 22. Such a system would enable the apparatus to have reduced thickness 108 without compromising on the image quality at small field of view.

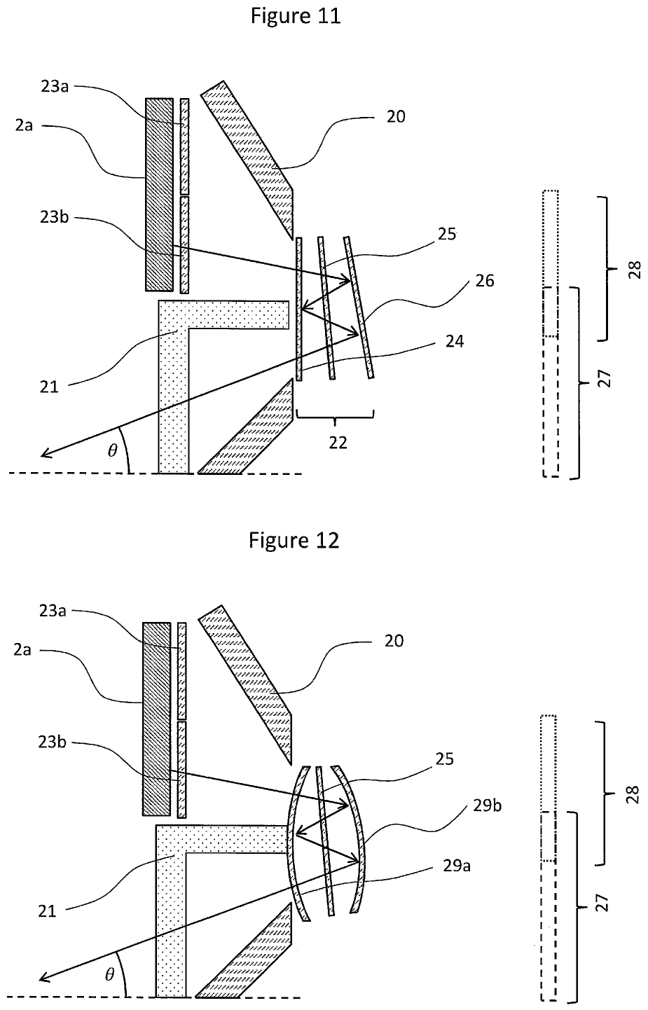

The principles of the fourth embodiment are illustrated in FIGS. 10 and 11, which show the different light paths for the top image panel of the apparatus. (Details of the surface curvature of the eyepiece element are omitted from FIGS. 9-12 for clarity.) FIG. 10 shows the optical path of rays emitted by the part of the image panel 2a further from the eyepiece element and which contribute to the central FoV of the virtual image of the image panel. The rays depicted in the figure are transferred through the system at a similar sequence as the third embodiment, except that light emitted from the part of the image panel further from the eyepiece element transmits through an optical module 23a which outputs a ray with a defined state of polarisation. The same ray then follows reflections and refractions by the reflective element 20 and eyepiece element 21, resulting in a virtual image with small field of view 27.

FIG. 11 shows the light path of rays which contribute to the peripheral FoV of the virtual image of the image panel. These rays are contributed by a different region of the image panel, eg the part of the image panel 2a nearer to the eyepiece element and, and may be guided through different components compared to the rays that contribute to smaller FoV image 27. In FIG. 11 the rays that contribute to the large FoV images 28 may originate from the lower half of the top image panel 2a. They transmit through a different optical module 23b which outputs a ray with a defined state of polarisation such that the emerging rays have a state of polarisation orthogonal to light emerging from the first optical module 23a. The emerging rays then enters a light guiding component 22 within which the ray undergoes at least three reflections before reemerging the element. The emerging ray is then refracted by the primary eyepiece segment of the eyepiece element 21 before being viewed by the user.

The function of the light guiding component 22, when combined with the magnifying power of the eyepiece 21, is to produce a virtual image of larger FoV 28 that merges with the virtual image of smaller field of view 27.

This embodiment may comprise a blocking means for blocking light emitted by the first part of the first display panel from entering the light guide. An example of a possible light guiding component is shown in FIG. 11. This exemplary component includes a reflective polariser 24, optical phase retarder 25, and a secondary reflective element 26. Although the sequence in which rays are transferred the sheets could be known (as described in U.S. Pat. No. 6,853,491B1 and EP2030186A1), in order for the images of different FoV 27, 28 to overlap, it may be necessary for the optical sheets 24-26 to be laid out such that they are tilted relative to each other. The reflective polariser 24 is arranged such that it will transmit light of the polarisation state output by the second optical module 23b but will block or substantially block light of the polarisation state output by the first optical module 23a.

If light that contributes to the larger FoV image 28 does not pass through the secondary segment of the eyepiece element, it may be necessary for the light guiding element 22 to have positive power or curvature to correct for optical aberrations. For example in FIG. 12 the light guide or optical sheets could be curved such that light is reflected off the curved surfaces 29a-b are magnified. In alternative arrangements, it may also be possible to design the light guide such that rays exiting the light guide do go through both refractive surfaces of the eyepiece element.

As the aim of the light guiding element 22 is to replace the apex of the reflective element from the original embodiment, its thickness should be thin enough such that it extends to no more than the projected intersection between the reflective surfaces of element 20.

### Embodiment 5

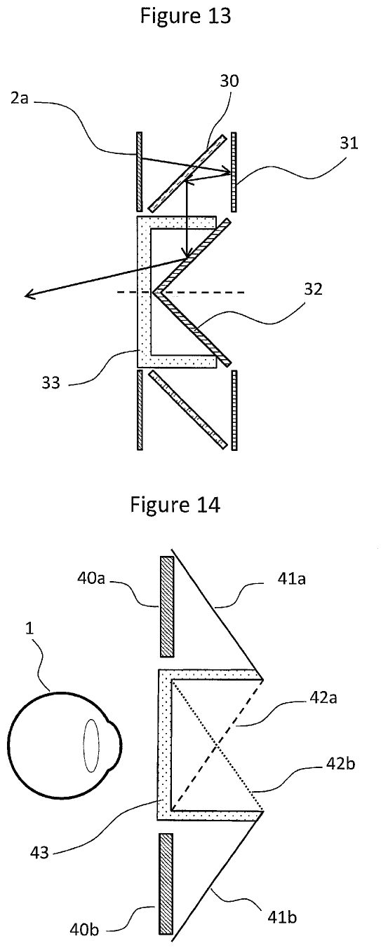

FIG. 13 shows the fifth embodiment of this invention. Here, a further reflective element is provided such that the light path from the first region of an image panel to the viewing zone further includes a reflection by the further reflective element. For example, a tilted reflective polariser or a partially reflective surface 30 is added such that the optical distance between the image panel 2a and the eyepiece element 33 is increased. Light emerging from the image panel is transmitted by the element 30, reflected by a primary reflective element 31, reflected by the partially reflective element 30, and is then refracted by the surface of the eyepiece element 33. The light then undergoes a further reflection, by one face of a secondary reflective element 32 and is directed towards the viewing zone. In this embodiment, the reflection by the primary reflective element 31 and the reflection by the face of the secondary reflective element 32 correspond to the two reflections by the reflective element 3 in FIG. 1. Details of the surface curvature of the eyepiece element 33 are omitted from FIG. 13 for clarity.

If the element 30 is a reflective polariser, then an additional quarter phase retarder may be added to the optical path between 30 and 31 such that the polarisation of light is rotated by 90 degree after the light passes through the phase retarder twice. This would allow the system to have higher optical efficiency.

This embodiment would allow the use of an eyepiece element with longer effective focal length or smaller magnification, allowing an image with high quality to be seen by the user. The advantages of this embodiment can also be achieved using other known arrangements for increasing the optical path length between the display panel 2a and the eyepiece element, which may include partially reflective mirrors and reflective polarisers to extend optical paths without increasing physical dimensions of the apparatus.

### Embodiment 6

FIG. 14 shows the sixth embodiment of this invention. This embodiment includes two image panels 40a-b which emit light at orthogonal or substantially polarisation states to one another. (The image panels 40a, 40b may for example each be embodied as an image panel and a polarising element disposed in the path of light emitted from the panel.) Light from the top image panel 40a is reflected by a first planar surface of the primary reflective element 41a, refracted by a first curved surface of the eyepiece element 43, reflected by a second reflective surface 42a, and refracted by a second curved surface of the eyepiece element before leaving the apparatus. (Details of the surface curvature of the eyepiece element are omitted from FIG. 14 for clarity.) Likewise, rays from the bottom image panel 40b are transferred from the panel to the eye through a similar sequence: rays are reflected by a different first planar surface of the primary reflective element 42b, refracted by a different surface of the eyepiece element 43, reflected by a second reflective surface 42b, and refracted by a second curved surface of the eyepiece element.

The reflective surfaces 42a-b may be reflective polarisers which transmits light at one state of polarisation and reflects light at an orthogonal state of polarisation. That is, the reflective surface 42a may substantially or completely reflect light of the polarisation state emitted by the image panel 40a and may substantially or completely transmit light of the polarisation state emitted by the display panel 40b, whereas the reflective surface 42b may substantially or completely reflect light of the polarisation state emitted by the image panel 40b and may substantially or completely transmit light of the polarisation state emitted by the display panel 40b. Additionally or alternatively, the primary reflective elements 41a, 41b may be reflective polarisers which transmit light at one state of polarisation and reflect light at an orthogonal state of polarisation. Hence light from the top half of the panel will not be affected by the surface 42b and light from the bottom half will not be affected by 42a. Such configuration may allow the system to have a larger overlap between the top image and the bottom image, which allows larger movement of the eye without seeing a gap between the two images, resulting in a larger “eye box” size, smoother overlapping between the top and bottom halves of the image, and more compact physical size.

In order for the crossed reflective polarisers 42a, 42b to be held in position, the reflective polarisers 42a, 42b may be embedded in glass or a transparent polymer in a geometry similar to “X-cube” light combiners commonly found in projectors. In an embodiment where this is done, one or more other elements such as the eyepiece element 43, the primary reflective element 41a and/or the primary reflective element 41b may also be embedded in the glass or polymer to hold it/them in a desired orientation relative to the reflective polarisers 42a, 42b.

### Embodiment 7

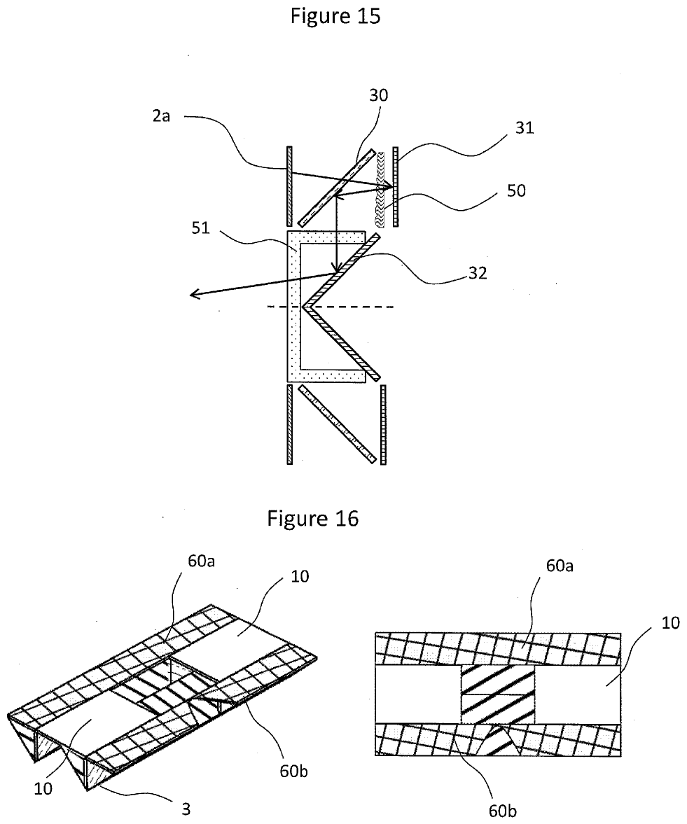

FIG. 15 shows the seventh embodiment of this invention. Details of the surface curvature of the eyepiece element are omitted from FIG. 15 for clarity. This embodiment mainly differs from the fifth embodiment as a lens array 50 is added into the system, in the optical path from the image panel 2a to the viewing zone. The lens array includes at least two small lenses (lenslets) located adjacent to each other. Each of the lenslet creates a small sub-section of a larger image, such that the images from all the lenslets would overlap and combine to a full image when viewed by the user.

This embodiment offers several advantages. Firstly, if the width of the lenslet used is smaller than 6 mm or the diameter of a human pupil (after accounting for the magnification of the eyepiece element), the system would be capable of displaying light field information. This means the system will be able to display 3D images that exhibit focus/accommodation depth cues to the user.

Secondly, using a lens array could reduce the power required by the eyepiece lens and the physical distances between the optical elements, thereby making the apparatus more compact.

Thirdly, if the lenslets in the lens array have focal lengths and widths that can be chosen independently for each lenslet, each of the lenslets could be individually optimised to correct for field-angle dependent aberrations such as field curvature, thereby improving the image quality of the system.

Although the position of the lens array 50 has been drawn to be located between the partially reflective element 30 and the reflective element 31, it is also possible for the lens array to be placed between other optical components as long as the lens array remains out of focus to the eye after the images have been magnified by the eyepiece element 51.

Additionally or alternatively, a lens array may be provided in the optical path from the image panel 2b to the viewing zone.

### Embodiment 8

FIG. 16 shows the eighth embodiment where, instead of having two image panels per eye and four image panels in total, at least one of the image panels 60a-b are shared by both eyes. As an example, in the embodiment of FIG. 16 one image panel (the upper image panel 60a) is shared by both eyes whereas the other image panel (the lower image panel 60b) is embodied as separate image panels for each eye. In other examples (not shown) both image panels may be shared by both eyes, or only the lower image panel may be shared by both eyes.

Such configuration could serve to lower the assembly cost of the system, and would also be particularly useful if the system offers a wide horizontal field of view.

### Embodiment 9

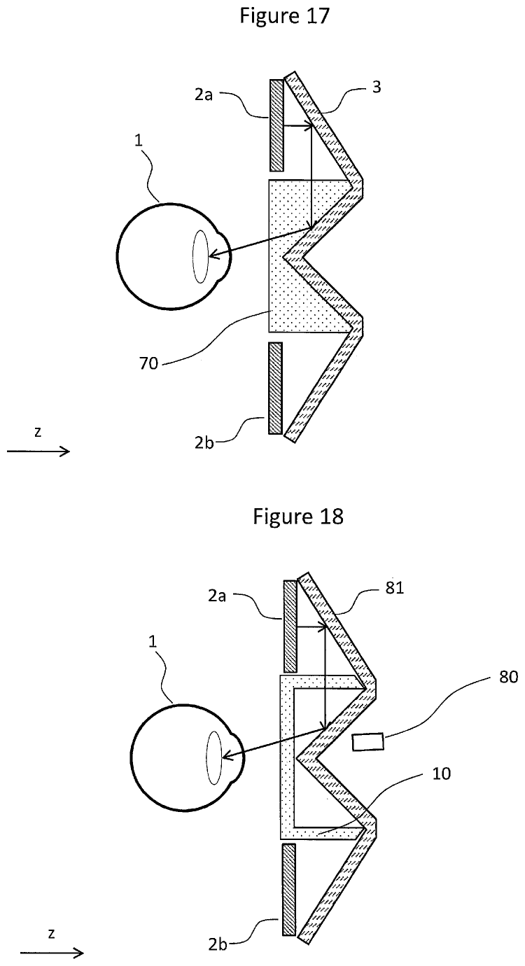

FIG. 17 shows the ninth embodiment where, instead of having a “U-shaped” eyepiece element (10, FIG. 6), the eyepiece element could be made from a single solid prism block 70, wherein at least two of the three surfaces where light enters or exits the prism could be curved or have the shape of a free-form Fresnel lens. Details of the surface curvature of the eyepiece element are omitted from FIG. 17 for clarity.

This configuration may reduce the alignment cost/requirement between the two curved surfaces of the eyepiece element.

### Embodiment 10

FIG. 18 shows the tenth embodiment wherein the system includes a gaze tracker 80 (preferably a separate gaze tracker is provided for each eye). Details of the surface curvature of the eyepiece element are omitted from FIG. 18 for clarity. The gaze tracker could monitor the position and/or orientation of the user's eye such that the images displayed on the panel 2a and/or the images displayed on the panel 2b could be subjected to transformation that depends on the monitored parameters of the eye such as position and/or orientation.

In a system without gaze trackers, the top and bottom image panels may appear misaligned if the eye is moved beyond a certain distance from the intended viewing position. Image transformation based on the gaze tracker could help to reverse this mis-alignment, thereby increasing the eye box size of the system and improving the system's image quality.

The preferred gaze tracker is based on an infrared camera and could include an infrared LED light source which illuminates the eye. However, the gaze tracker could also be based on other known technologies including other camera based or electrooculography based eye trackers.

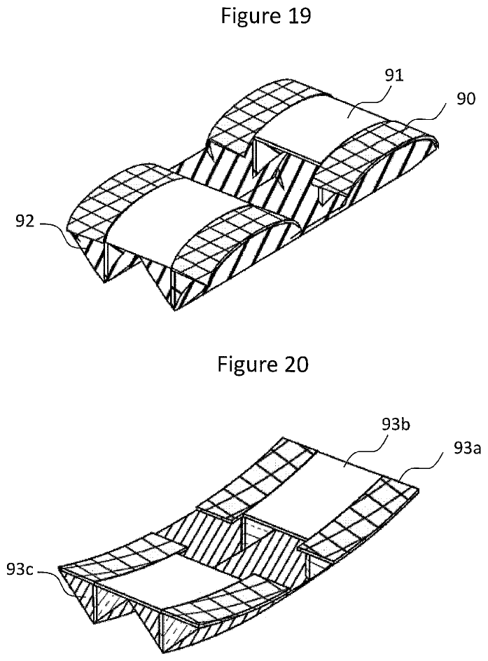

Moreover, the gaze tracker could also be placed in a position that is complementary to the shape of the rest of the apparatus. For example, FIG. 19 shows the gaze tracker as being hidden within the concave side of the “W-shaped” primary reflective element 81. This would allow the gaze tracker to be installed without contributing to additional thickness of the apparatus. In addition, the primary reflective element 81 could also be partially transparent in infrared such that the image of the eye could be obtained by the gaze tracker without introducing loss in optical efficiency for visible light.

Additional functions may also arise if the gaze tracker is positioned such that it images the eye through the primary segment of the eyepiece element 10. Because the eyepiece element has split optical axis, a single gaze tracker would be able to obtain stereoscopic information of the eye. This would allow the 3D position of the eye to be located using a single gaze tracker.

### Embodiment 11

FIG. 19 shows the eleventh embodiment where the image panels 90 are curved. The eyepiece element 91 could also be curved or meniscus such that it bends in the direction of the panel. Having curved image panels may have several advantages. Firstly, if the panels are bent away from the head as shown in the figure, the configuration would allow better image quality as field curvature caused by the eyepiece can be compensated by the curvature of the panel.

In addition, when the eye rotates to view the edge of the curved panel, the angle between the normal of the panel surface and the eye's gaze direction will be reduced. This could improve the luminance performance of the image panel at large FoV.

On the other hand, if the image panels are bent in the opposite direction, different advantages will arise (FIG. 20, showing that the image panel 93a, eyepiece element 93b, and primary reflective element 93c bend towards the position of the viewer's direction rather than away from the eye as it was shown in FIG. 19). Such geometry would make the apparatus feel lighter and less bulky as the panels may have a snug fit with the shape of the user's face.

Although the invention has been shown and described with respect to a certain embodiment or embodiments, equivalent alterations and modifications may occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein exemplary embodiment or embodiments of the invention. In addition, while a particular feature of the invention may have been described above with respect to only one or more of several embodiments, such feature may be combined with one or more other features of the other embodiments, as may be desired and advantageous for any given or particular application.

### INDUSTRIAL APPLICABILITY

Industrial application will be mainly for wearable displays, in particular for achieving small and light weight Head Mounted Displays (HMD). The principal advantage of the invention allows the apparatus to have a compacted form factor with weight distribution close to the user's face without compromising on image quality and resolution. The primary invention uses simple plain reflectors and an eyepiece element that creates at least two overlapping virtual images from two image panels per eye, allowing the user to see a single, continuous, wide field of view (FoV) virtual image.

Hardware manufactured using this invention may be useful in the fields of virtual reality (VR) and augmented reality (AR) for both consumer and professional markets. HMD manufactured by this invention could have applications including everyday use, gaming, entertainment, task support, medical, industrial design, navigation, transport, translation, education, and training.

### REFERENCE SIGNS LIST

1: Eye
2: (a-b) Image Panel
3: Primary Reflective Element
4: Eyepiece element
5: Eyepiece element in the form of a Fresnel lens
6: Illumination Unit of Image Panel
7: Light modulating unit of image panel
10: Eyepiece element according to the third embodiment
11: Primary segment of the eyepiece element according to the third embodiment
12: Secondary segment of the eyepiece element according to the third embodiment
13: Primary segment of the eyepiece element in the form of a Fresnel lens according to the third embodiment
14: Secondary segment of the eyepiece element in the form of a Fresnel lens according to the third embodiment
15: Joint between the primary and secondary segment of the eyepiece element according to the third embodiment
20: Primary Reflective Element according to the fourth embodiment
21: Eyepiece element according to the fourth embodiment
22: Light guiding component according to the fourth embodiment
23 (a-b): Optical modules according to the fourth embodiment
24: Reflective polarisers according to the fourth embodiment
25: Optical phase retarder according to the fourth embodiment
26: Secondary reflective element according to the fourth embodiment
27: Smaller field of view virtual image of the top panel according to the fourth embodiment
28: Larger field of view virtual image of the top panel according to the fourth embodiment
29 (a-b): Reflective/Partially reflective surfaces according to the fourth embodiment
30: Partially reflective element according to the fifth embodiment
31: Primary reflective element according to the fifth embodiment
32: Secondary reflective element according to the fifth embodiment
33: Eyepiece element according to the fifth embodiment
40 (a-b): Image panels according to the sixth embodiment
41 (a-b): Primary reflective element according to the sixth embodiment
42 (a-b): Reflective polarisers according to the sixth embodiment
43: Eyepiece element according to the sixth embodiment
50: Lens array according to the seventh embodiment
51: Eyepiece element according to the seventh embodiment
60 (a-b): Image panels according to the eighth embodiment
70: Eyepiece element according to the ninth embodiment
80: Gaze Tracker according to the tenth embodiment
81: Primary reflective element according to the tenth embodiment
90: Curved image panel according to the eleventh embodiment
91: Eyepiece element according to the eleventh embodiment
92: Primary reflective element according to the eleventh embodiment
93 (a-c): Curved optical components according to the eleventh embodiment
101: Separation of optical axis of primary eyepiece element
102 (a-b): Virtual images from the image panels
103: Overlapping region of the virtual images of the image panels
104: Field of view of the top panel visible to the eye.
105: Plane of discontinuity of the primary reflective element that divides the optical paths for the top and the bottom image panels.
106 (a-b): Field of View of the image panels as limited by the most restrictive optical surface within the optical path of each image panel.
107 (a-b): Angular spread of light emerging from different regions of the image panel
108: Thickness of the optical apparatus
109: Angular extent of the secondary reflective surface of the primary reflective element

1. An optical system comprising:
a first display panel for displaying a first image;
a second display panel for displaying a second image;
first and second eyepiece elements, the first eyepiece element having a first optical axis and the second eyepiece element having a second optical axis, the first optical axis extending generally parallel to, but offset from, the second optical axis;
a first reflective element for directing light from the first display panel along a first optical path through the first eyepiece element to a viewing zone of the optical system for forming a first virtual image of the first image; and
a second reflective element for directing light from the second display panel along a second optical path through the second eyepiece element to the viewing zone of the optical system for forming a second virtual image of the second image, the first optical path being different from the second optical path, and the first and second virtual images overlapping one another;
wherein the first display panel is on the same side of the first reflective element as the viewing zone; and
wherein the first eyepiece element is on the same side of the first reflective element as the viewing zone.

2. The optical system as claimed in claim 1 wherein the second display panel is on the same side of the second reflective element as the viewing zone, and wherein the second eyepiece element is on the same side of the second reflective element as the viewing zone.

3. The optical system as claimed in claim 2 wherein the first display panel is laterally spaced apart from the second display panel, and wherein the first and second eyepiece elements are provided between the first display panel and the second display panel.

4. The optical system as claimed in claim 1, wherein, for light emitted by at least a part of the first display panel, the first optical path comprises multiple reflections by the first reflective element.

5. The optical system as claimed in claim 1 wherein the first display panel has a luminance profile that varies over the area of the first display panel.

6. The optical system as claimed in claim 5 wherein the luminance profile of a region of the first display panel closer to the first eyepiece element is narrower than the luminance profile of a region of the first display panel further from the first eyepiece element.

7. The optical system as claimed in claim 5 wherein the first display panel comprises an image display panel disposed in the path of light from a directional backlight.

8. The optical system as claimed in claim 5, wherein the first display panel comprises a light directing means disposed in the path of light from an image display panel.

9. The optical system as claimed in claim 1 wherein the first eyepiece element comprises at least one Fresnel lens.

10. The optical system as claimed in claim 1 wherein the first eyepiece element comprises a first segment and a second segment, the first eyepiece element and the first reflective element being arranged such that, for light emitted by at least a part of the first display panel, the first optical path comprises, in sequence, a first reflection by the first reflective element, refraction by the first segment of the first eyepiece element, a second reflection by the first reflective element, and refraction by the second segment of the first eyepiece element.

11. The optical system as claimed in claim 10 wherein the second segment of the first eyepiece element extends in a direction crossed with the first segment.

12. The optical system as claimed in claim 10, wherein the first eyepiece element comprises at least one Fresnel lens, and the first segment of the first eyepiece element comprises a first Fresnel lens and/or the second segment of the first eyepiece element comprises a second Fresnel lens.

13. The optical system as claimed in claim 1 wherein the first reflective element comprises a light guide arranged such that, for light emitted by a first part of the first display panel, the first optical path does not pass through the light guide, and such that, for light emitted by a second part of the first display panel, the first optical path passes through the light guide.

14. The optical system as claimed in claim 13 wherein the second part of the first display panel is closer to the viewing zone than is the first part of the first display panel.

15. The optical system as claimed in claim 13 and comprising blocking means for blocking light emitted by the first part of the first display panel from entering the light guide.

16. The optical system as claimed in claim 1 and comprising a further reflective element arranged such that the first light path further includes a reflection by the further reflective element.

17. The optical system as claimed in claim 1 wherein the first display panel is arranged to emit light of a first polarisation and the second display panel is arranged to emit light of a second polarisation orthogonal or substantially orthogonal to the first polarisation; wherein the first reflective element is arranged to substantially reflect light of the first polarisation and to substantially transmit light of the second polarisation, and wherein the second reflective element is arranged to substantially reflect light of the second polarisation and to substantially transmit light of the first polarisation.

18. The optical system as claimed in claim 1 and comprising a lens array provided in the first optical path.

19. The optical system as claimed in claim 1 and comprising a gaze tracker for determining the position and/or orientation of an eye of a user of the optical system.

20. (canceled)

21. (canceled)

22. A head mounted display comprising the optical system as defined in claim 1.
